(19) United States
(12) Patent Application Publication
(10) Pub. No.: US 2004/0101249 A1
(43) Pub. Date: May 27, 2004

(54) Method for manufacturing all-fiber device

(76) Inventors: Shiao-Min Tseng, Hsinchu (TW); Nan-Kuang Chen, Taipei Hsien (TW)

Correspondence Address: BIRCH STEWART KOLASCH & BIRCH, PO BOX 747, FALLS CHURCH, VA, 22040-0747, US

(21) Appl. No.: 10/465,846

(22) Filed: Jun. 20, 2003

(30) Foreign Application Priority Data
Jun. 25, 2002 (TW) 91113891

(51) Int. Cl. G02B 6/26; G02B 6/34

(52) U.S. Cl. 385/50; 385/37

(57) ABSTRACT

A method for manufacturing an all-fiber device. The method comprises the following steps. First, a recess with a predetermined radius is formed on a semiconductor substrate. A first optical fiber is then fixed in the recess by an adhesive. Subsequently, a cladding layer of the first optical fiber is polished to form a first side-polished optical fiber with a first polished surface near a core region of the first optical fiber. Then, the first optical fiber is separated from the semiconductor substrate by a liquid. Like the first side-polished optical fiber, a second side-polished optical fiber with a second polished surface is formed. Finally, after the first polished surface is aligned and in contact with the second polished surface, the first side-polished optical fiber and the second side-polished optical fiber are fused to form the all-fiber device. A coupling region is formed between the first and second polished surfaces.

### BACKGROUND OF THE INVENTION

1. Field of the Invention

The present invention relates to an all-fiber device, and in particular to an all-fiber device manufactured by polishing and fusing.

2. Description of the Related Art

In a fiber-optic transmission system, optical signals must often be separated, coupled, or filtered. Thus, specific optical devices performing the above functions are required. All-fiber devices are optical devices with the above characteristics.

Basically, all-fiber devices can be divided into fused or polished types. The performances of fused and polished all-fiber devices are different.

At present, fused all-fiber devices have been mass-produced and are widely used, as detailed in “Single-mode fused biconical couplers for wavelength division multiplexing with channel spacing between 100 and 300 nm” in “Lightwave Technology, vol. 6, pp. 113-119” by M. Eisenmann and E. Weidel in 1988. First, jacket layers of two optical fibers are partially removed. Then, exposed cladding layers are attached. Subsequently, the optical fibers fused by flame heating. During the fusion, both ends of the optical fibers are extended so that core regions of the optical fibers are near each other to form a functional region, in which cross-section areas of the cladding layers are largely reduced. For example, before fusing, the cross-section area of the adjacent optical fibers is substantially 125 μm×250 μm. However, the cross-section area of the narrowest portion of the functional region of the fused all-fiber device is substantially reduced to 20 μm×20 μm. Accordingly, the guiding property of the high-index core nearly disappears. In the narrowest functional region, the transmission of the signal depends on an interface between the cladding layer and air. Thus, the fused all-fiber device is also referred to as a cladding-mode coupling device.

The polished all-fiber device has been mass-produced recently. The polished all-fiber device is also referred to as an evanescent-field coupling device. At present, only S. M. Tseng and his research team can produce the polished all-fiber device with high productivity and long interaction length and no negligible losses, as detailed in “Precision side-polished fibers with a long interaction length” in “Japanese J. Appl. Phys., vol. 36, pp. L1179-1181” by S. M. Tseng et al. in 1997. Also, in “High-performance side-polished fibers and applications as liquid crystal clad fiber polarizers” in “J. Lightwave Technol., vol. 15, pp. 1554-1558” by S. M. Tseng et al. in 1997; and “Surface-polarition fiber polarizer: design and experiment” in “Japanese J. Appl. Phys., vol. 36, pp. L488-L490” by S. M. Tseng et al. in 1997. As well, in U.S. Pat. No. 5,781,675 (Method for preparing fiber-optic polarizer) by S. M. Tseng et al, and U.S. Pat. No. 5,809,188 (Tunable fiber filters or reflectors) by S. M. Tseng et al.

Furthermore, in U.S. Pat. No. 5,457,758, an add/drop device, produced by micro-type fiber-optic devices, is disclosed. However, the optical fiber disclosed in this patent has twin cores. When such special optical fiber is combined with a normal single core optical fiber, many problems occur. Thus, it is difficult to apply in the practical field, particularly while connecting with widely used single-core fibers.

With respect to the add/drop device, another is disclosed in U.S. Pat. No. 6,212,318 B1 by C. V. Cryan. The optical fiber add/drop filter includes first and second elongated photosensitive optical fibers, each having opposed first and second ends and including a core and a cladding. The cladding of the first optical fiber is optically coupled to the cladding of the second optical fiber at a coupler. A first fiber Bragg grating is etched into a second end of the first fiber for converting light propagating in a first direction through either of the core of the cladding of the first fiber into light propagating in an opposite direction through the other of said core and cladding of said second fiber. A second fiber Bragg grating is etched into a first end of the second fiber for converting light propagating in a first direction either core or the cladding of the second fiber into light propagating in an opposite direction through the other of the core and cladding of the second fiber. The first and second fiber Bragg gratings are on opposite sides of the coupler while the conversion between the core mode and the cladding mode happens. However, the single-mode optical fiber includes only one core mode HE₁₁, but includes many cladding modes. Thus, the filtering frequency spectrum is in question, as detailed in “Fiber grating spectra” in “J. Lightwave Technology., vol. 15, pp. 1277-1294” by T. Erdogan in 1997.

Another method for fabricating the all-fiber add/drop device is to directly dispose the Bragg grating in the coupling area of the fiber-optic coupler. However, if the coupler is fused, the tilt angle between the grating and the coupler waist must be precisely controlled to attain high quality filtering optical frequency, as detailed in “Bragg grating in 2×2 symmetric fused couplers: influence of the tilt on the wavelength response” in “IEEE Photonics Technology Letters, vol. 11, pp. 1434-1436” by E. Martin in 1999. In addition, if the coupler is a polished coupler with a polished base made of glass or quartz, its polished loss is very considerable, as detailed in “Compact all-fiber add-drop-multiplexer using fiber Bragg gratings” in “IEEE Photonics Technology Letters, vol. 8, pp. 1331-1333” by I. Baumann in 1999.

### SUMMARY OF THE INVENTION

Accordingly, an object of the invention is to provide a method for manufacturing an all-fiber device by polishing and fusing.

Another object of the invention is to provide an all-fiber device with a low loss, which is based on the evanescent-field interaction and can be easily incorporated into widely used fiber-optic systems.

In this invention, a method for manufacturing an all-fiber device is provided, comprising the following steps. First, a recess with a predetermined radius is formed on a semiconductor substrate. Second, a first optical fiber is fixed in the recess by an adhesive. Subsequently, a cladding layer of the first optical fiber is polished to form a first side-polished optical fiber with a first polished surface. The first polished surface is near a core region of the first optical fiber. Then, the first optical fiber is separated from the semiconductor substrate by a liquid. Like the first side-polished optical fiber, a second side-polished optical fiber with a second polished surface is formed. Finally, after the first polished surface is aligned and in contact with the second polished surface, the first side-polished optical fiber and the second side-polished optical fiber are fused to form the all-fiber device. A coupling region is formed between the first and second polished surfaces.

In a preferred embodiment, the method further comprises heating of the coupling region of the all-fiber device by a fiber-optic fusing machine so that a length of the coupling region is extended to adjust an optical field of an output signal.

Furthermore, the method comprises covering the all-fiber device with a UV-cured material, and applying an ultraviolet light thereto to protect the all-fiber device.

Furthermore, the method comprises piling the coupling regions of a plurality of all-fiber devices, and fusing and extending the all-fiber devices to form a multi-channel all-fiber device.

Furthermore, the method comprises surrounding the coupling regions of the multi-channel all-fiber device with a tube, and a step of fixing the tube and the multi-channel all-fiber device with the adhesive.

In another embodiment, fusing the first side-polished optical fiber and the second side-polished optical fiber is performed by flame fusing, wire heating, RF heating, flash welding, or laser-beam fusing.

In another embodiment, the method further comprises fixing the optical fibers with the adhesive near both sides of the polished surfaces after aligning and contacting the first and second polished surfaces.

In another embodiment, the method further comprises the following steps. The first side-polished optical fiber is disposed on a first frame, and the first frame includes at least two alignment members. The second side-polished optical fiber is disposed on a second frame, and the second frame includes at least two holes. After the alignment members of the first side-polished optical fiber are aligned with the holes of the second side-polished optical fiber, the first frame and the second frame are fixed so that the first polished surface is aligned and in contact with the second polished surface.

Furthermore, the first side-polished optical fiber and the second side-polished optical fiber are fixed by vacuum.

Furthermore, after the first side-polished optical fiber and the second side-polished optical fiber are disposed on the first frame and the second frame respectively, the optical fibers are separated from the semiconductor substrate by chemicals, an organic solvent, or an erosive liquid.

In another embodiment, the method further comprises the following steps. A Bragg grating is formed on the coupling region of the all-fiber device by UV exposure, and the coupling region is formed with a non-grating coupling part and a grating coupling part. An optical signal is input into the all-fiber device, and the non-grating coupling part of the coupling region is fused. A length of the non-grating coupling part of the all-fiber device is extended, and the optical signal to a predetermined output end is selectively determined.

Furthermore, the method comprises covering a coating layer on the coupling region of the all-fiber device, the coating layer provided with a temperature-compensation function.

Furthermore, the coating layer is a protective cover of polymer, a metallic tube, a ceramic tube, a tube of glass, or a tube with temperature-compensation function.

In another embodiment, the first optical fiber and the second optical fiber are multi-mode fibers.

In another embodiment, the method further comprises the following steps. A Bragg grating is formed on the coupling region of the all-fiber device by UV exposure, and the coupling region is formed with a non-grating coupling part and a grating coupling part. An optical signal is input into the all-fiber device, and the non-grating coupling part of the coupling region is fused. A length of a portion, excluding the grating coupling part, of the all-fiber device is extended, and the optical signal to a predetermined output end is selectively determined.

Furthermore, the method comprises covering a coating layer on the coupling region of the all-fiber device, the coating layer provided with a temperature-compensation function.

In another embodiment, the optical fibers include a plastic protective cover at both ends of the recess.

In another embodiment, the method further comprises the following steps. Adhesive is disposed at both ends of the recess, and is moved toward the center of the recess evenly, by capillarity. The optical fiber is disposed in the recess.

In another embodiment, the method further comprises the following steps. The optical fiber is disposed in the recess. The adhesive is disposed at both ends of the recess, and the adhesive is moved toward a center of the recess by capillarity so that the adhesive is evenly distributed in a gap between the recess and the optical fiber.

In another embodiment, the method further comprises the following steps. A Bragg grating is formed on the coupling region of the all-fiber device by UV exposure, and the coupling region is formed with a non-grating coupling part and a grating coupling part. Mixed optical signals are input into the first optical fiber of the all-fiber device, and a phase of the coupling region is properly adjusted so that one of the mixed optical signals is output from the second optical fiber and other mixed optical signals are output from an output end of the first optical fiber.

The invention also provides another method for manufacturing an all-fiber device. The method comprises the following steps. First, a first all-fiber device is formed according to the above method. Then, a Bragg grating is formed on the coupling region of the first all-fiber device by UV exposure. After mixed optical signals are input into the first all-fiber device, one of the mixed optical signals is output from one predetermined end of the first all-fiber device and other mixed optical signals are output from the other predetermined end of the first all-fiber device. Second, a second all-fiber device is formed according to the above method, and the Bragg grating is formed on the coupling region of the second all-fiber device by UV exposure. Finally, the second all-fiber device is connected to the first all-fiber device so that one of the mixed optical signals is output from the second all-fiber device.

The invention also provides another method for manufacturing an all-fiber device. The method comprises the following steps. First, a first all-fiber device is formed according to the above method, and a Bragg grating is formed on the coupling region of the first all-fiber device by UV exposure. After mixed optical signals are input into a first end of the first all-fiber device, one of the mixed optical signals is output from a second end of the first all-fiber device and other mixed optical signals are output from a third end of the first all-fiber device. Second, a second all-fiber device is formed according to the above method, and another Bragg grating is formed on the coupling region of the second all-fiber device by UV exposure. Finally, a first end of the second all-fiber device is connected to the third end of the first all-fiber device so that after the mixed optical signals from the third end of the first all-fiber device are input to the first end of the second all-fiber device, one of the mixed optical signals is output from a second end of the second all-fiber device and other mixed optical signals are output from a third end of the second all-fiber device.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a linear mask progressively wider toward each end;

FIG. 2A is a longitudinal sectional view of a silicon substrate;

FIG. 2B is a cross section of a silicon substrate;

FIG. 3 is a longitudinal sectional view showing an optical fiber fixed in a V-shaped recess;

FIG. 4 is a cross section showing a polished optical fiber fixed in a V-shaped recess;

FIG. 5 is a top schematic view showing a polished optical fiber disposed on a frame;

FIG. 6 is a top schematic view showing a plurality of side-polished optical fibers disposed on the frame;

FIG. 7 is a schematic view showing an assembly of two frames;

FIG. 8A is a schematic view showing polished surfaces of two side-polished optical fibers fused by a laser beam;

FIG. 8B is a schematic view showing polished surfaces of two side-polished optical fibers fused by a flame;

FIG. 8C is a schematic view showing regions, located outside polished surfaces of two side-polished optical fibers, fixed by an adhesive before the side-polished optical fibers fused;

FIG. 9A is a schematic view showing the length of an all-fiber device adjusted by fusing;

FIG. 9B is a schematic view showing a protective layer formed on a coupling region of an all-fiber device;

FIG. 10A is a schematic view showing a multi-channel micro-type fiber-optic device fabricated by fusing a plurality of all-fiber devices;

FIG. 10B is a schematic view showing a coupling region of a multi-channel all-fiber device protected by a metallic tube;

FIG. 11 is a schematic view showing a Bragg grating formed on a coupling region of an all-fiber device by UV light;

FIG. 12 is a schematic view showing an add/drop multiplexer protected with a tube;

FIG. 13A is a schematic view of a drop mode of a micro-type fiber-optic coupler;

FIG. 13B is a schematic view of an add mode of a micro-type fiber-optic coupler; and

FIG. 14A and FIG. 14B show a series-type add/drop multiplexer.

### DETAILED DESCRIPTION OF THE INVENTION

In this embodiment, a substrate of a polished optical fiber is made of material with oriented etching, such as a semiconductor substrate. For example, a silicon wafer may be used.

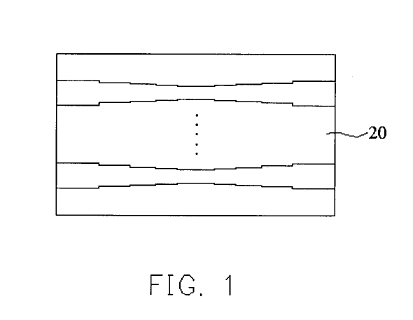

FIG. 1 is a schematic view of a linear mask progressively wider toward each end. By a method for manufacturing an integrated circuit, a curved type graph progressively wider toward each end is formed on a silicon wafer by the mask 20 as shown in FIG. 1. The silicon wafer is preferably (100)-oriented; however is not limited thereto.

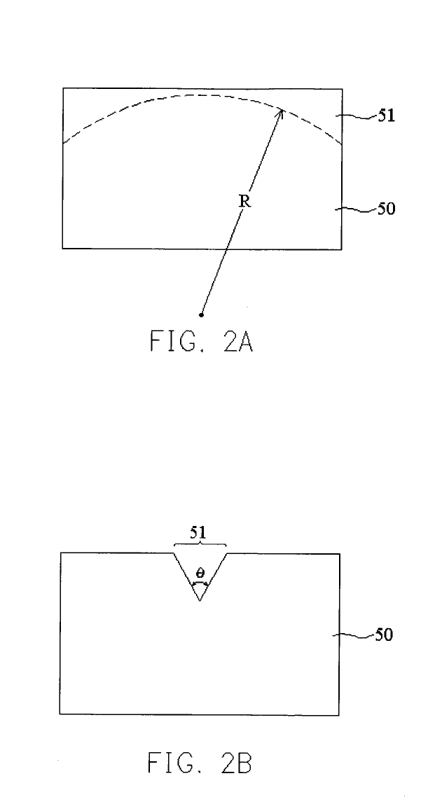

FIG. 2A is a longitudinal sectional view of a silicon substrate, and FIG. 2B is a cross section of a silicon substrate. A V-shaped recess 51 with a radius R is formed using the oriented etching characteristics of the silicon wafer 50. In FIG. 2A, a V-shaped recess with a long radius R is precisely formed by etching. For example, R may be 1000 cm so that the polished optical fiber is provided with a long and effective interaction-length. In FIG. 2B, the V-shaped recess 51 is provided with an angle θ (=70.53°). In addition, a plurality of V-shaped recesses 51 can be formed by the method for manufacturing the integrated circuit at the same time. It is noted that the sizes of the recesses 51 may be the same or different. A coupling region of the polished optical fiber can be adjusted by changing the radius of the recess 51.

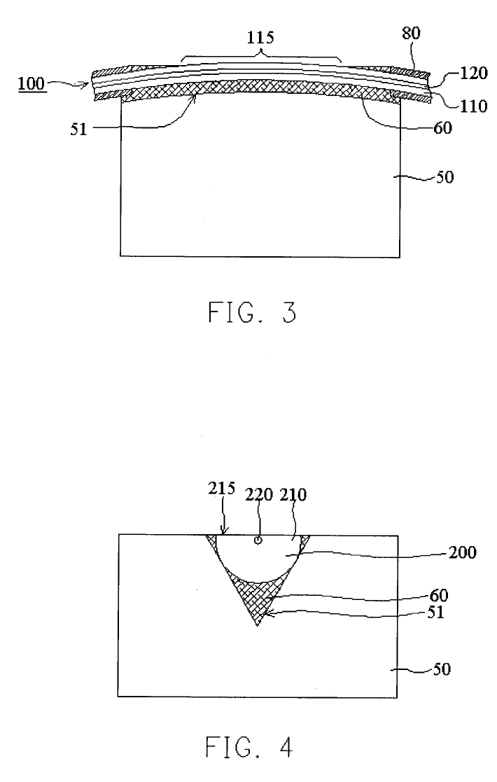

FIG. 3 is a longitudinal sectional view showing an optical fiber fixed in a V-shaped recess. First, an adhesive 60 is added at both ends of the recess 51, and it moved toward the center of the recess 51 by capillarity. Then, an exposed portion of an optical fiber 100 is fixed in the recess 51 with the adhesive 60 as shown in FIG. 3. However, a jacket layer 80, located at both ends of the recess 51, of the optical fiber, is not removed, protecting the optical fiber 100 from breaking during polishing. The depth of the recess 51 is designed in a manner such that a core region 120 of the optical fiber 100 is partially exposed on the silicon wafer after the optical fiber 100 is disposed in the recess 51. During polishing, only the exposed potion 115 is removed.

In addition, the optical fiber 100 may be firstly disposed in the recess 51. Then, the adhesive 60 is added at both ends of the recess 51, and is quickly moved toward a gap between the optical fiber 100 and the recess 51 by capillarity as shown in FIG. 3.

FIG. 4 is a cross section showing the polished optical fiber fixed in the V-shaped recess. Furthermore, a cladding layer 110 of the optical fiber 100 protruding form a surface of the silicon substrate is polished until the polished surface 115 of the optical fiber 100 is flush with the surface of the silicon substrate 50. As shown in FIG. 4, a core region 220 of a side-polished optical fiber 200 is extremely close to the polished surface 215 of the optical fiber.

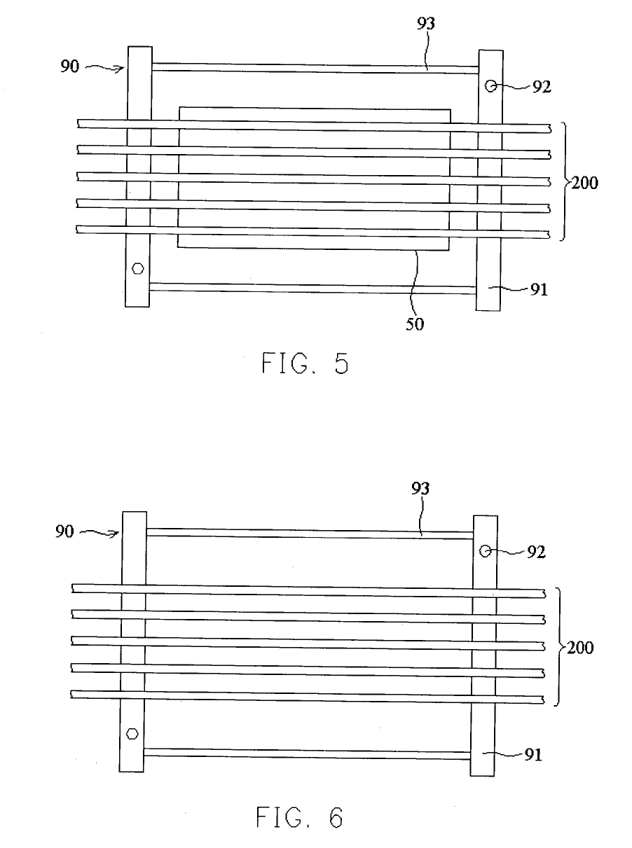

FIG. 5 is a top schematic view showing a polished optical fiber disposed on a frame. As shown in FIG. 5, a plurality of side-polished optical fibers 200 are disposed on the silicon substrate 50, and polished surfaces 115 are formed by polishing the side-polished optical fibers 200. Two supports 91 are disposed at each side of the silicon substrate 50 respectively, and each of the supports 91 includes a plurality of grooves (not shown). A gap between the adjacent grooves is the same as that between the adjacent optical fibers. Thus, the optical fibers 200, located in the recesses 51 of the silicon substrate 50, are disposed on the grooves of the supports 91 respectively. In addition, the frame 90 further includes two shafts 93, connecting the supports 91 to maintain the distance therebetween. If the supports are made of the silicon substrate, a plurality of grooves can be easily formed thereon by a method for manufacturing the integrated circuit.

FIG. 6 is a top schematic view showing a plurality of side-polished optical fibers disposed on a frame. The side-polished optical fibers 200 are separated from the recesses 51 by chemicals, an organic solvent, or an erosive liquid, such as a solution of sulfuric acid and hydrogen dioxide. Thus, the side-polished optical fibers 200, separated form the silicon substrate, are fixed on the frame 90.

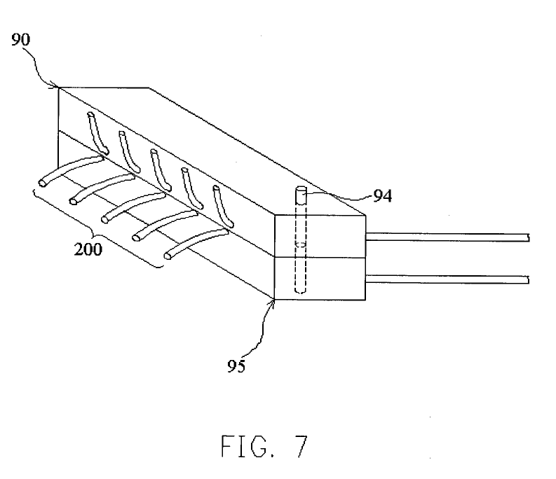

FIG. 7 is a schematic view showing an assembly of two frames. In addition, referring to FIG. 5 and FIG. 7, lock holes 92 of the frames 90, 95 are aligned. Then, a rod 94 is inserted into the lock holes 92 of the frames 90, 95. Thus, the frames 90, 95 are fixedly combined. As shown in FIG. 7, the polished surfaces of the side-polished optical fibers 200 on the frames are also aligned and abutted. In other words, in this invention, the polished surfaces of the side-polished optical fibers are automatically aligned and abutted by fixing the frames. It is noted that the manner for aligning the polished surfaces of the optical fibers is not limited to the manner shown in figures.

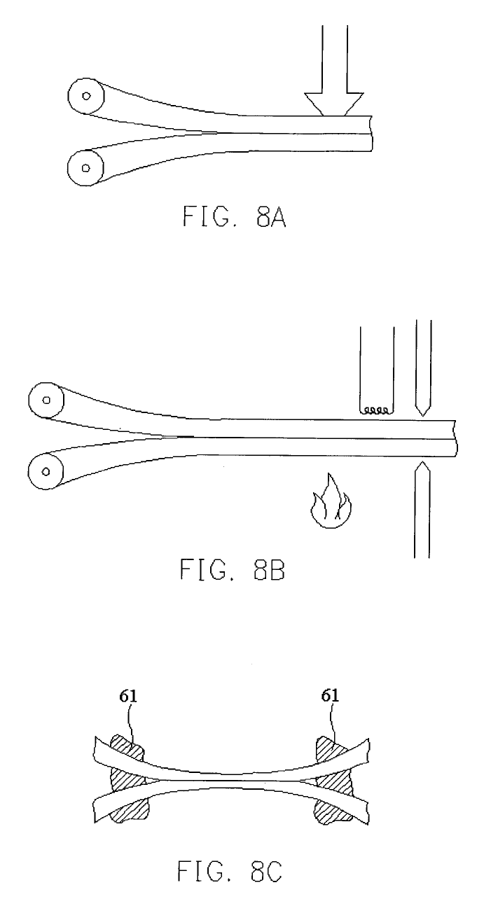

After fixing the frames along with the side-polished optical fibers, the polished surfaces of the side-polished optical fibers are automatically aligned and abutted in a free space. Then, referring to FIG. 8A, a laser with a predetermined energy intensity is directly induced on the side-polished optical fibers on the frame so that the polished surfaces of the side-polished optical fibers fused to form an all-fiber device, as detailed in “Laser drawing of optical fibers” in “Appl. Opt., vol. 13, pp. 1383-1386” by U. C. Paek in 1974. Also, in “Carbon dioxide laser fabrication of fused-fiber couplers and tapers” in “Appl. Opt., vol. 38, pp. 68456848” by T. E. Dimmick, G. Kakarantzas, T. A. Birks, and P. St. J. Russell in 1999. Also, in “Miniature all-fiber devices based on CO₂ laser microstruturing of tapered fibers” in “Opt. Lett., vol. 26, pp. 1137-1139” by T. E. Dimmick, G. Kakarantzas, T. A. Birks, and P. St. J. Russel in 2001. Or, referring to FIG. 8B, the polished surfaces of two side-polished optical fibers fused by flame fusing, wire heating, RF heating, flash welding, or laser-beam fusing. Furthermore, referring to FIG. 8C, the portions, located outside of the polished surfaces of two side-polished optical fibers, are fixed with the adhesive 61, flash welding, or laser-beam fusing.

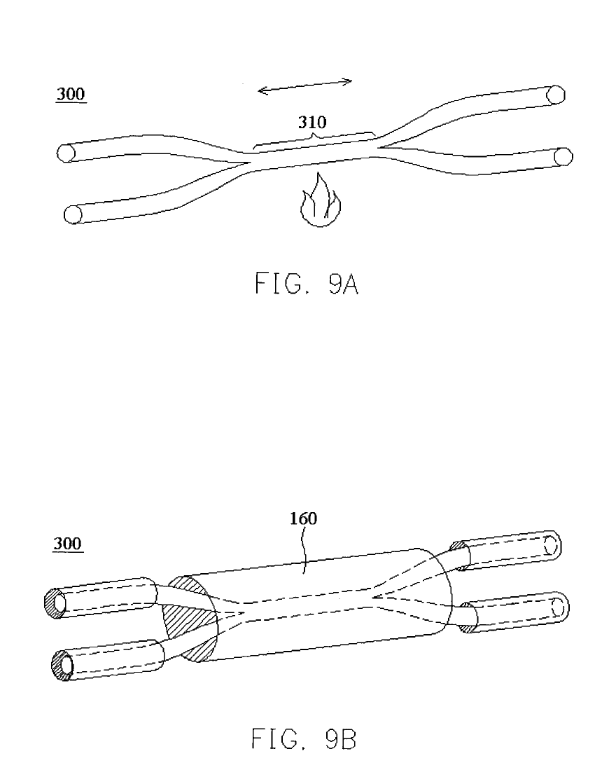

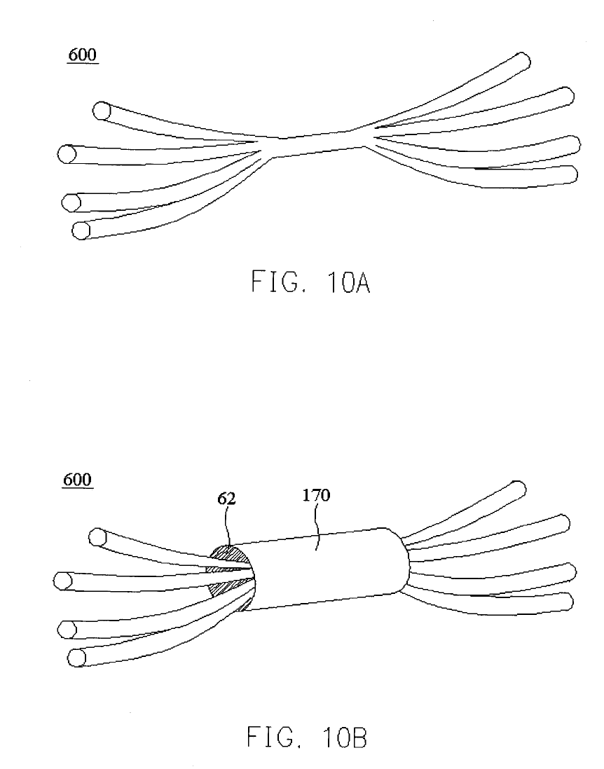

Referring to FIG. 9A, after the all-fiber devices are separated from the frames, the length of the coupling region 310 of the all-fiber device 300 is extended by fusing to adjust the strength of the optical field of the output end to a predetermined value. The all-fiber device 300 is covered by a UV-cured material 160, and an ultraviolet light is applied on the UV-cured material 160 to protect the all-fiber device 300 as shown in FIG. 9B.

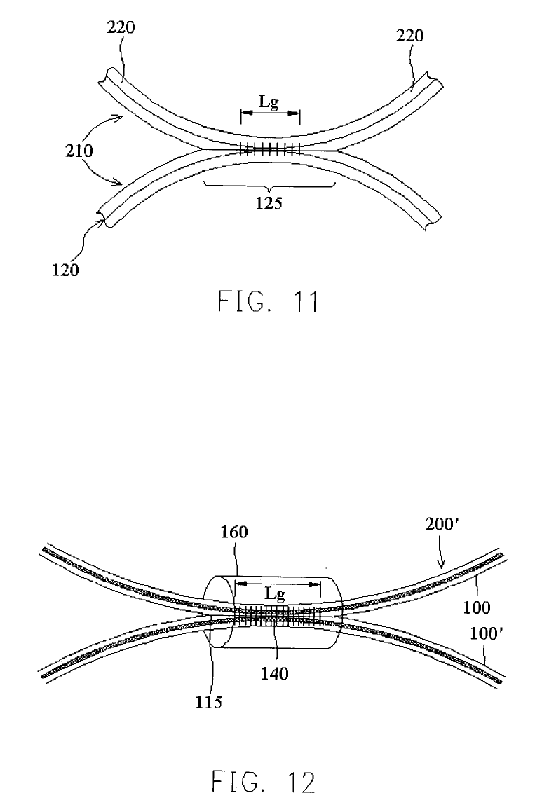

In this embodiment, the length of the side-polished optical fiber can be increased very little by fusing and heating. Furthermore, as shown in FIG. 10A, after the coupling regions 310 of a plurality of all-fiber devices are contacted, the coupling regions 310 are fused to form a multi-channel all-fiber device 600. Then, the coupling region of the multi-channel all-fiber device 600 is surrounded with a tube 170, and the tube 170 and the multi-channel all-fiber device 600 are fixed together with the adhesive 62 as shown in FIG. 10B.

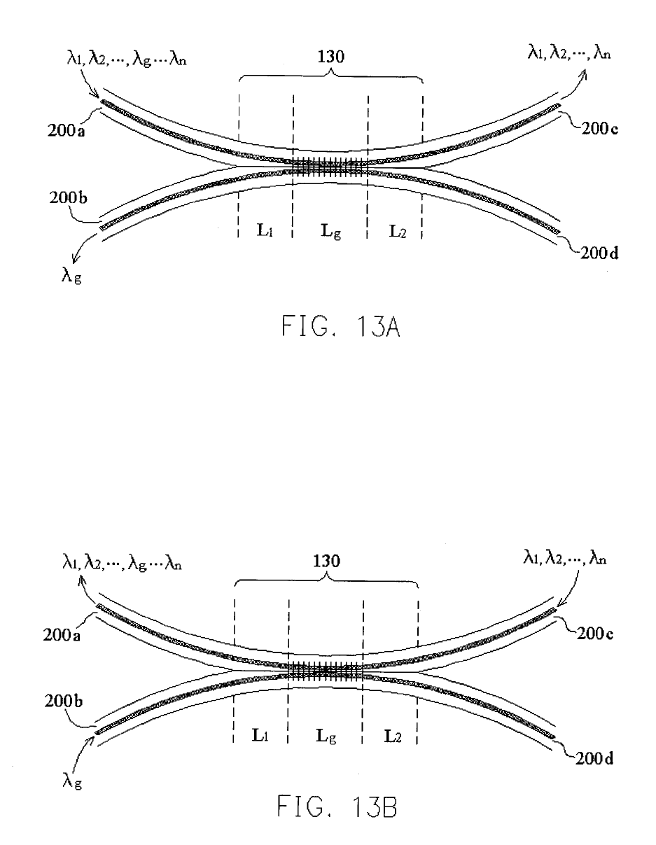

In this embodiment, a coupling region with a long interaction-length can be obtained by polishing and fusing. The coupling regions' coupling mechanism is an optical evanescent-field type. Furthermore, as shown in FIG. 11, a Bragg grating is formed in the coupling region by an ultraviolet light to fabricate an add/drop multiplexer, as detailed in “Fiber Bragg grating technology fundamentals and overview” in “J. Lightwave Technology, vol. 15, pp. 1263-1276” by K. O. Hill and G. Meltz in 1997, and in “Optical add/drop multiplexer based on UV-written grating in a fused 100% coupler” in “Electronics Letters, vol. 33, pp. 803-804” by F. Bakhti, P. Sansonetti, C. Sinet, L. Gasca, L. Martineau, S. Lacroix, X. Daxhelet, and F. Gonthier in 1997.

Referring to FIG. 12, the coupling region can be covered by a protective member to prevent the coupling region from deforming or breaking. The protective member is a protective cover of polymer, a metallic tube, a ceramic tube, a tube of glass, or a tube with temperature-compensation function.

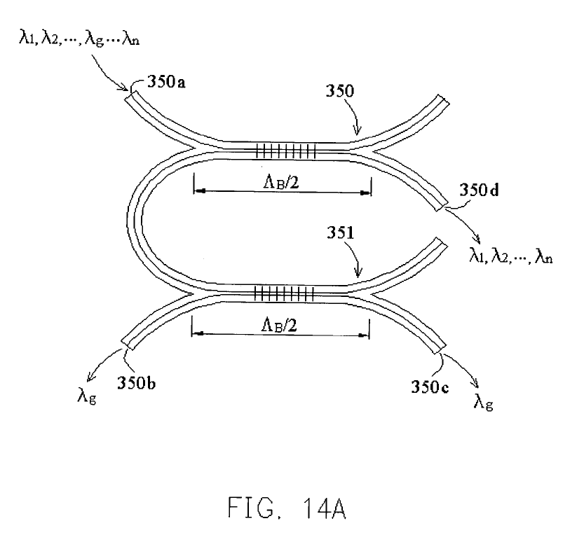

FIG. 13A is a schematic view of a drop mode of a micro-type fiber-optic coupler. As shown in FIG. 13A, the coupling region 130 can be further divided into a portion L₁, L₂ without the Bragg grating, and a portion Lg with the Bragg grating. Mixed optical signals with multi-waveband λ₁, λ₂, . . . , λ_{g}, . . . , λₙ are input into one end 200a of the micro-type fiber-optic coupler. After the optical signal with the wavelength λ_{g} is reflected to the potion L₁ by the Bragg grating 140 located at the portion L_{g}, it is output at the other end 200b, as detailed in “Guided normal modes of two parallel circular dielectric rods” in “Journal of the Optical Society of America, vol. 63, No. 8, pp. 944-950” by W. Wijngaard in 1973, and in “Cross-talk fiber-optic temperature sensor” in “Applied Optics, vol. 22, pp. 464-477” by G. Meltz, J. R. Dunphy, M. W. Morey, and E. Snitzer in 1983. When the length of the coupling region of two optical fibers is substantially A_{B}/² and the optical signal is propagated in one of the optical fibers, the optical evanescent field of the optical fiber is almost coupled to a core region of the other optical fiber. When the length of the coupling region of two optical fibers is substantially AB and the optical signal is propagated in one of the optical fibers, the optical evanescent field of the optical fiber is firstly almost coupled to a core region of the other optical fiber, and then completely coupled to the core region of the original optical fiber to propagate. Thus, in this embodiment, when the length of the coupling region of the optical add/drop multiplexer is substantially AB, the mixed optical signals with wavebands λ₁, λ₂, . . . , λₙ are output from another end 200c after passing through. L₁, L_{g}, L₂. FIG. 13B is a schematic view of an add mode of a micro-type fiber-optic coupler. As shown in FIG. 13B, when the mixed optical signals with wavebands λ₁, λ₂, . . . , λₙ are input into the end 200c and the optical signal with the waveband λ_{g} is input into the end 200b, the mixed optical signals with wavebands λ₁, λ₂, . . . , λₙ and the optical signal with the waveband λ_{g} are combined and output from the end 200a.

In this embodiment, the coupling region of the all-fiber device, including the portions L₁, L_{g}, L₂ as shown in FIG. 13A, can be selected based on the fusing position of the coupling region. The refractive index of the optical fiber can be changed by applying UV light to the coupling region of the all-fiber device. That is, when the coupling region of the all-fiber device is exposed to UV light, the signal may be selectively output from the end 200c or an end 200d. Furthermore, by properly extending the portion, without the grating, of the coupling region by fusing, the strength of the filtering wave from different output ends is optimized.

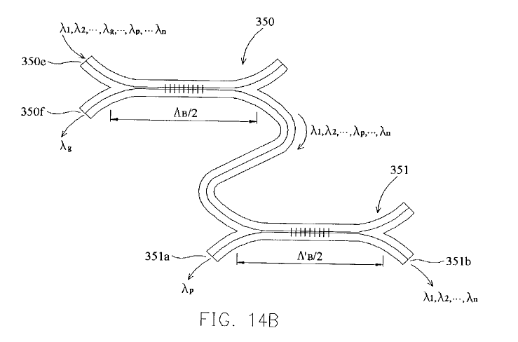

FIG. 14A and FIG. 14B show a series-type add/drop multiplexer. As shown in FIG. 14A, mixed optical signals with multi-waveband λ₁, λ₂, . . . , λ_{g}, . . . , λₙ are input into one end 350a of the first optical add/drop multiplexer 350, and the optical signal with waveband λ_{g} appears at the other end 350b of the first optical add/drop multiplexer 350. Then, the optical signal with the waveband λ_{g} is output at another end 350c of the first optical add/drop multiplexer 350, and mixed optical signals with wavebands λ₁, λ₂, . . . , λₙ except λ_{g} are output at another end 350d of the first optical add/drop multiplexer 350. Referring to FIG. 14B, mixed optical signals with multi-waveband λ₁, λ₂, . . . , λ_{g}, . . . , λₚ, . . . , λₙ are input into one end 350e of the first optical add/drop multiplexer 350, and the optical signal with the waveband λ_{g} appears at the other end 350f of the first optical add/drop multiplexer 350. Then, the optical signal with the waveband λₚ is output at one end 351a of the second optical add/drop multiplexer 351, and mixed optical signals with wavebands λ₁, λ₂, . . . , λₙ except λ_{g} and the waveband λₚ are output at the other end 351b of the second optical add/drop multiplexer 351.

As stated above, by polishing the optical fiber in the silicon V-shaped recess and fusing, the all-fiber device with a long interaction length, a low loss, and high yields can be obtained.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A method for manufacturing an all-fiber device, comprising:
(a) forming a recess with a predetermined radius on a semiconductor substrate;
(b) fixing a first optical fiber in the recess with an adhesive;
(c) polishing a cladding layer of the first optical fiber to form a first side-polished optical fiber with a first polished surface, wherein the first polished surface is near a core region of the first optical fiber;
(d) separating the first optical fiber from the semiconductor substrate by a liquid;
(e) repeating steps (a) to (d) to form a second side-polished optical fiber with a second polished surface; and
(f) after aligning and contacting the first and second polished surfaces, fusing the first side-polished optical fiber and the second side-polished optical fiber to form the all-fiber device, wherein a coupling region is formed between the first and second polished surfaces.

2. The method as claimed in claim 1, further comprising:
heating of the coupling region of the all-fiber device by a fiber-optic fusing machine so that a length of the coupling region is extended to adjust an optical field of an output signal.

3. The method as claimed in claim 1, wherein fusing of the first side-polished optical fiber and the second side-polished optical fiber is performed by flame fusing, wire heating, RF heating, flash welding, or laser-beam fusing.

4. The method as claimed in claim 1, further comprising, after aligning and contacting the first and second polished surfaces, fixing of the optical fibers with the adhesive disposed near both sides of the polished surfaces.

5. The method as claimed in claim 2, further comprising covering the all-fiber device with a UV-cured material, and applying an ultraviolet light to the UV-cured material to protect the all-fiber device.

6. The method as claimed in claim 2, further comprising:
piling the coupling regions of a plurality of all-fiber devices; and
fusing and extending the all-fiber devices to form a multi-channel all-fiber device.

7. The method as claimed in claim 6, further comprising:
surrounding the coupling regions of the multi-channel all-fiber device with a tube; and
fixing the tube and the multi-channel all-fiber device with the adhesive.

8. The method as claimed in claim 1, further comprising:
disposing the first side-polished optical fiber on a first frame, wherein the first frame includes at least two alignment members;
disposing the second side-polished optical fiber on a second frame, wherein the second frame includes at least two holes; and
after aligning the alignment members of the first side-polished optical fiber and the holes of the second side-polished optical fiber, fixing the first frame and the second frame so that the first polished surface is aligned and in contact with the second polished surface.

9. The method as claimed in claim 8, wherein the first side-polished optical fiber and the second side-polished optical fiber are fixed by vacuum.

10. The method as claimed in claim 1, further comprising:
forming of a Bragg grating on the coupling region of the all-fiber device by UV exposure, the coupling region formed with a non-grating coupling part and a grating coupling part; and
inputting an optical signal into the all-fiber device, fusing the non-grating coupling part of the coupling region while extending a length of the non-grating coupling part of the all-fiber device, selectively determining the optical signal at a predetermined output end to output.

11. The method as claimed in claim 10, further comprising covering a coating layer on the coupling region of the all-fiber device, the coating layer provided with a temperature-compensation function.

12. The method as claimed in claim 1, wherein the first optical fiber and the second optical fiber are multi-mode fibers.

13. The method as claimed in claim 8, wherein the optical fibers are separated from the semiconductor substrate by chemicals, an organic solvent, or an erosive liquid, after disposing the first side-polished optical fiber and the second side-polished optical fiber on the first frame and the second frame respectively.

14. The method as claimed in claim 11, wherein the coating layer is a protective cover of polymer, a metallic tube, a ceramic tube, a tube of glass, or a tube with temperature-compensation function.

15. The method as claimed in claim 1, further comprising:
forming a Bragg grating on the coupling region of the all-fiber device by UV exposure, the coupling region formed with a non-grating coupling part and a grating coupling part; and
inputting an optical signal into the all-fiber device, fusing the non-grating coupling part of the coupling region while extending a length of a portion, excluding the grating coupling part, of the all-fiber device, selectively determining the optical signal at a predetermined output end.

16. The method as claimed in claim 15, further comprising:
covering a coating layer on the coupling region of the all-fiber device, the coating layer provided with a temperature-compensation function.

17. The method as claimed in claim 16, wherein the coating layer is a protective cover of polymer, a metallic tube, a ceramic tube, a tube of glass, or a tube with temperature-compensation function.

18. The method as claimed in claim 1, wherein the optical fibers include a plastic protective cover at each end of the recess.

19. The method as claimed in claim 1, further comprising:
disposing the adhesive at each end of the recess, the adhesive moving toward a center of the recess evenly, by capillarity; and
disposing the optical fiber in the recess.

20. The method as claimed in claim 1, further comprising:
disposing the optical fiber in the recess; and
disposing the adhesive at each end of the recess, the adhesive moving toward a center of the recess by capillarity so that the adhesive is evenly distributed in a gap between the recess and the optical fiber.

21. The method as claimed in claim 1, further comprising:
forming a Bragg grating on the coupling region of the all-fiber device by UV exposure, the coupling region formed with a non-grating coupling part and a grating coupling part; and
inputting mixed optical signals into the first optical fiber of the all-fiber device, properly adjusting a phase of the coupling region so that one of the mixed optical signals is output from the second optical fiber and other mixed optical signals are output from an output end of the first optical fiber.

22. A method for manufacturing an all-fiber device, comprising:
forming a first all-fiber device according to the method claimed in claim 1;
forming a Bragg grating on the coupling region of the first all-fiber device by UV exposure, wherein after mixed optical signals are input into the first all-fiber device, one of the mixed optical signals is output from one predetermined end of the first all-fiber device and other mixed optical signals are output from the other predetermined end of the first all-fiber device;
forming a second all-fiber device according to the method claimed in claim 1;
forming a Bragg grating on the coupling region of the second all-fiber device by UV exposure; and
connecting the second all-fiber device to the first all-fiber device so that one of the mixed optical signals is output from the second all-fiber device.

23. A method for manufacturing an all-fiber device, comprising:
forming a first all-fiber device according to the method claimed in claim 1;
forming a Bragg grating on the coupling region of the first all-fiber device by UV exposure, wherein after mixed optical signals are input into a first end of the first all-fiber device, one of the mixed optical signals is output from a second end of the first all-fiber device and other mixed optical signals are output from a third end of the first all-fiber device;
forming a second all-fiber device according to the method claimed in claim 1;
forming another Bragg grating on the coupling region of the second all-fiber device by UV exposure; and
connecting a first end of the second all-fiber device to the third end of the first all-fiber device so that after the mixed optical signals from the third end of the first all-fiber device are input to the first end of the second all-fiber device, one of the mixed optical signals is output from a second end of the second all-fiber device and other mixed optical signals are output from a third end of the second all-fiber device.
